(19) United States
(12) Patent Application Publication
(10) Pub. No.: US 2026/0336487 A1
(43) Pub. Date: Oct. 29, 2026

(54) CONVEYANCE SEAT

(71) Applicant: TS TECH CO., LTD., Asaka-shi (JP)

(72) Inventor: Jinichi TANABE, Tochigi (JP)

(21) Appl. No.: 19/656,595

(22) Filed: Apr. 23, 2026

Related U.S. Application Data
(60) Provisional application No. 63/793,753, filed on Apr. 24, 2025.

(30) Foreign Application Priority Data
Jul. 24, 2025 (JP) 2025-124307

(51) Int. Cl. B60N 2/427; B60N 2/75; B60R 21/02

(52) U.S. Cl. CPC B60N 2/42754; B60N 2/763; B60R 21/02; B60R 2021/022

(57) ABSTRACT

A conveyance seat includes a protection device that is provided at each of side portions of a seatback and protects a seated occupant by causing a bulging object to bulge, and an armrest that supports an arm portion of the seated occupant. The seatback includes a side frame provided at a side portion in a seat width direction. The protection device is attached to an outer surface of the side frame, and the armrest is attached to the outer surface of the side frame and is disposed at a position close to the protection device. The armrest is provided with an arm deformation portion that is deformed according to bulging and deployment of the bulging object to allow the bulging and deployment of the bulging object.

### CROSS-REFERENCE TO RELATED APPLICATIONS

This application claims priority to U.S. Provisional Patent Application No. 63/793,753, filed on Apr. 24, 2025, and Japanese Patent Application No. 2025-124307, filed on Jul. 24, 2025, both of which are hereby incorporated herein by reference in their entireties for all purposes.

### 1. TECHNICAL FIELD

The present invention relates to a conveyance seat, and more particularly to a conveyance seat including an armrest provided on a side portion of a seat main body.

### 2. DESCRIPTION OF THE RELATED ART

Hitherto, there has been known a vehicle seat including an armrest provided on a side portion of a seatback and supporting an arm portion of a seated occupant.

A vehicle seat described in JP 2023-107927 A includes a side airbag device that is provided at each of side portions of a seatback and protects a seated occupant by causing an airbag to bulge when an external impact is applied, and an armrest that supports an arm portion of the seated occupant.

The armrest is pivotably assembled to a side frame of the seatback via an arm pivoting shaft. The armrest is pivotable between a “stored position” where the armrest extends in an up-down direction along the side frame and a “use position” where the armrest pivoting from the stored position is positioned and extends forward from the side frame.

By the way, in a conveyance seat including a side airbag device and an armrest as disclosed in JP 2023-107927 A, it has been required that an airbag can appropriately bulge and be deployed.

For example, it has been required to devise an arrangement and a configuration of the armrest so that the armrest does not affect the bulging and deployment (bulging and deployment direction) of the airbag.

An object of the present invention is to provide a conveyance seat that enables bulging and deployment of an airbag in the seat including an airbag device and an armrest.

Another object of the present invention is to provide a conveyance seat in which an arrangement and a configuration of an armrest are devised so as not to affect bulging and deployment of an airbag.

### SUMMARY OF THE INVENTION

The problems are solved by a conveyance seat including a seat main body according to the present invention, the conveyance seat including: a protection device that is provided at a side portion of the seat main body and protects a seated occupant by causing a bulging object to bulge when an external impact is applied; and an armrest that is provided at the side portion of the seat main body, in which the seat main body includes a side frame provided at the side portion of the seat main body in a seat width direction, the protection device is attached to an outer surface of the side frame, the armrest is attached to the outer surface of the side frame and is disposed at a position close to the protection device, and the armrest is provided with an arm deformation portion that is deformed according to bulging and deployment of the bulging object to allow the bulging and deployment of the bulging object.

With the above configuration, it is possible to implement the conveyance seat that enables appropriate bulging and deployment of the airbag.

More specifically, in the conveyance seat, the armrest is provided with the arm deformation portion that is deformed according to the bulging and deployment of the bulging object (for example, an airbag) to allow the bulging and deployment of the airbag. As a result, when the airbag bulges and is deployed, the arm deformation portion of the armrest is deformed, so that it is possible to suppress an influence on the bulging and deployment (bulging and deployment direction) of the airbag.

Preferably, the arm deformation portion is provided at a portion of the armrest close to the protection device.

Preferably, the armrest is configured to be switchable between a stored position where the armrest extends in an up-down direction along the side frame and a use position where the armrest moving from the stored position extends forward from the side frame, and the arm deformation portion is provided at each of a side portion of the armrest close to the protection device, and a front portion of the armrest when the armrest is at the stored position.

Preferably, the armrest is disposed so as to sandwich the protection device with the side frame in the seat width direction, and the arm deformation portion is provided at a side portion of the armrest close to the protection device.

With the above configuration, when the airbag bulges and is deployed, the arm deformation portion of the armrest can be actively deformed, so that it is possible to further suppress an influence on the bulging and deployment of the airbag.

Preferably, the armrest is attached so as to be pivotable with respect to the side frame and is switchable between a stored position where the armrest extends in an up-down direction along the side frame and a use position where the armrest pivoting from the stored position extends forward from the side frame, the armrest includes an arm frame that serves as a framework, and an arm padding material that covers the arm frame, the arm frame includes a support frame portion that supports an arm portion of the seated occupant when the armrest is at the use position, and a side frame portion that is positioned on a side of the armrest that is opposite to a side where the protection device is positioned, and the arm deformation portion is provided at a side portion of the armrest that is positioned on the side where the protection device is positioned, and is a portion including the arm padding material.

Preferably, the arm frame includes: the support frame portion that is a planar frame extending in the seat width direction; the side frame portion that is a planar frame extending from one end portion of the support frame portion in an extending direction of the support frame portion, in a direction orthogonal to the extending direction of the support frame portion; and an inclined frame portion that is a planar frame coupling the other end portion of the support frame portion in the extending direction and an extending end portion of the side frame portion and extending in an inclined manner.

Preferably, the arm frame is a frame having an L-shaped cross section.

With the above configuration, when the airbag bulges and is deployed, the arm deformation portion of the armrest is deformed, so that it is possible to further suppress an influence on the bulging and deployment of the airbag.

Preferably, the armrest is attached to the side frame via an arm attachment bracket, and the arm attachment bracket is disposed at a position downward of the protection device on the side frame.

As described above, the assembling strength of the armrest can be enhanced by assembling the armrest to the side frame via the arm attachment bracket.

Further, an assembly position of the armrest and an assembly position of the airbag device can be different from each other in the up-down direction.

Preferably, the armrest is pivotably attached to the side frame via an arm attachment bracket, and is switchable between a stored position where the armrest extends in an up-down direction along the side frame and a use position where the armrest pivoting from the stored position extends forward from the side frame, and when the armrest is at the use position, the armrest is disposed at a position different from the protection device in a seat side view.

With the above configuration, interference between the armrest and the bulging and deployed airbag can be suppressed when the armrest is at the use position.

Preferably, the seat main body includes a seat cushion, a seatback, and a headrest, the seat cushion includes a cushion frame, a padding material, and a skin material, the seatback includes a back frame, a padding material, and a skin material, the headrest includes a head frame, a padding material, and a skin material, the armrest includes an arm frame, an arm padding material, and an arm skin material, the conveyance seat further includes a reclining device that pivotably couples the seatback to the seat cushion, a rail device that supports the seat cushion so as to be movable in a front-rear direction with respect to a conveyance floor, and a height adjustment device that supports the seat cushion so as to be movable in an up-down direction with respect to the rail device, the headrest is attached to the seatback so as to be movable in the up-down direction, and the armrest is pivotably attached to a side portion of the seatback via an arm attachment bracket.

With the above configuration, it is possible to implement the conveyance seat including the plurality of movable devices, in which the arrangement and the configuration of the armrest are devised so as not to affect the bulging and deployment of the airbag.

According to the present invention, it is possible to implement the conveyance seat that enables appropriate bulging and deployment of the airbag. In addition, it is possible to implement the conveyance seat in which the arrangement and the configuration of the armrest are devised so as not to affect the bulging and deployment of the airbag.

According to the present invention, when the airbag bulges and is deployed, the arm deformation portion of the armrest is deformed, so that it is possible to suppress an influence on the bulging and deployment (bulging and deployment direction) of the airbag.

According to the present invention, the assembling strength of the armrest can be enhanced by assembling the armrest to the side frame via the arm attachment bracket. Further, an assembly position of the armrest and an assembly position of the airbag device can be different from each other in the up-down direction.

According to the present invention, interference between the armrest and the bulging and deployed airbag can be suppressed when the armrest is at the use position.

Further, according to the present invention, it is possible to implement the conveyance seat including the plurality of movable devices, in which the arrangement and the configuration of the armrest are devised so as not to affect the bulging and deployment of the airbag.

### BRIEF DESCRIPTION OF THE DRAWINGS

FIG. 1 is a perspective view of a conveyance seat and is a view illustrating a state in which an armrest is at a use position;

FIG. 2 is a side view of the conveyance seat and is a view illustrating a state in which the armrest is at a stored position;

FIG. 3 is a front view of the conveyance seat and is a view illustrating an airbag device and the armrest;

FIG. 4 is a perspective view of a seat frame;

FIG. 5 is an exploded perspective view of a back frame, an arm attachment bracket, and an armrest frame;

FIG. 6A is a side view of the back frame, the arm attachment bracket, and the airbag device;

FIG. 6B is a side view of the back frame, a reinforcing portion, and a hooking portion;

FIG. 7 is a rear view of the back frame, the arm attachment bracket, the armrest, and the airbag device;

FIG. 8A is a cross-sectional view taken along line A-A in FIG. 3 and is a view illustrating a state in which the armrest is at the stored position before the airbag bulges;

FIG. 8B is a view illustrating a state in which the airbag bulges and the arm deformation portion is deformed;

FIG. 9A is a cross-sectional view taken along line A-A of FIG. 3 and is a view illustrating a first modification of the armrest;

FIG. 9B is a view illustrating a state in which the airbag bulges and the arm deformation portion is deformed;

FIG. 10A is a cross-sectional view taken along line A-A in FIG. 3 and is a view illustrating a second modification of the armrest; and

FIG. 10B is a view illustrating a state in which the airbag bulges and the arm deformation portion is deformed.

### DETAILED DESCRIPTION

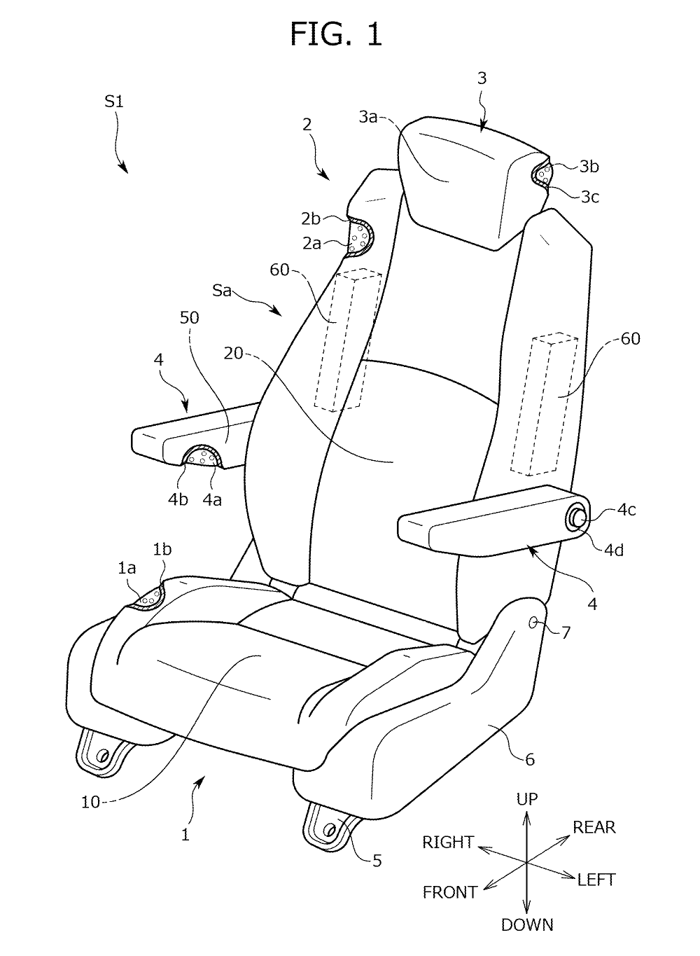

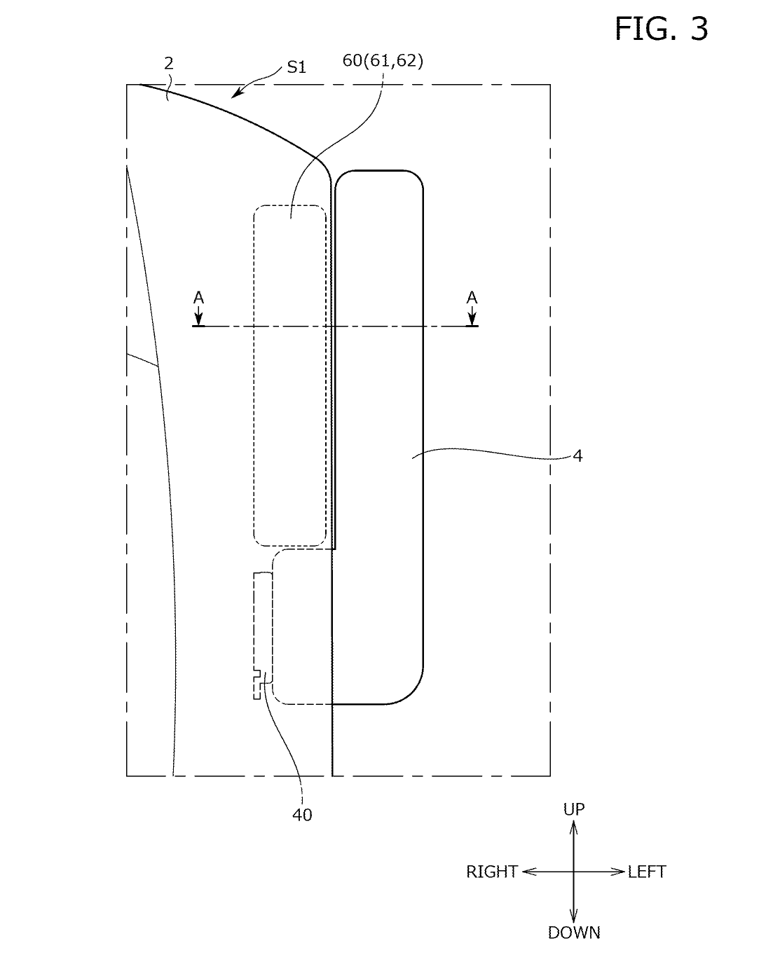

Embodiments of the present invention are described below with reference to FIGS. 1-10B.

The present embodiment relates to a “conveyance seat” that enables appropriate bulging and deployment of an airbag in the seat including an airbag device and an armrest.

A side on which a seated occupant is seated with respect to a seatback of the conveyance seat is a front side (seat front side). Further, a side on which the seated occupant is seated with respect to a seat cushion is an upper side (seat upper side).

### Conveyance Seat

As illustrated in FIGS. 1-5, a conveyance seat S1 is a vehicle seat, and is, for example, a front seat disposed at a front position of a vehicle. The conveyance seat S1 may be a middle seat or a rear seat.

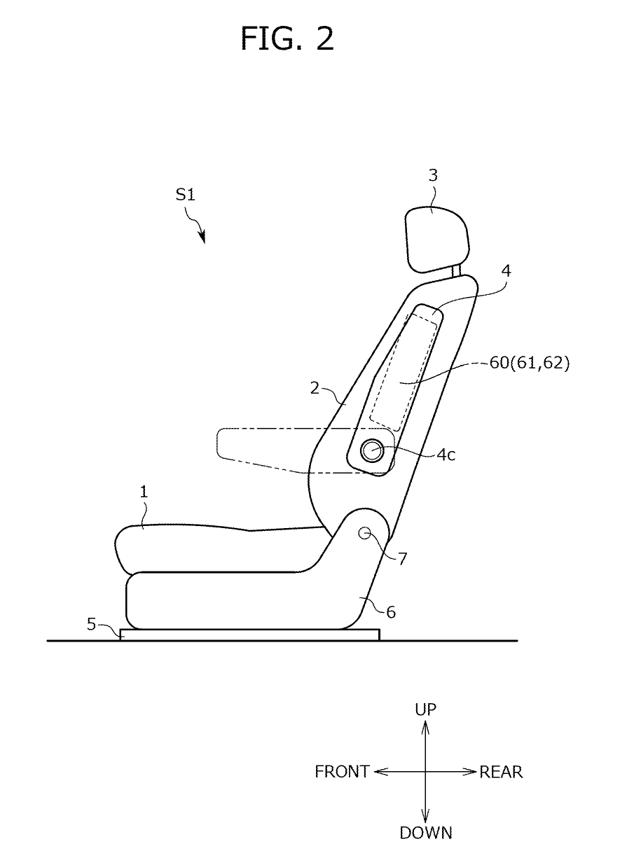

The conveyance seat S1 includes an armrest 4 at a side portion of a seat main body Sa, and the armrest 4 is configured to be movable between a “deployed position” illustrated in FIG. 1 and a “stored position” illustrated in FIG. 2. Specifically, the armrest 4 is assembled to a side frame 21 of a seatback 2 via an arm attachment bracket 40. Shapes and configurations of the side frame 21 and the arm attachment bracket 40 are devised so as to increase an assembling strength of the armrest 4.

In addition, the conveyance seat S1 includes an airbag device 60 provided at the side portion of the seat main body Sa, and an arrangement and a configuration of the armrest 4 (arm attachment bracket 40) with respect to the airbag device 60 are devised so as not to affect bulging and deployment (bulging and deployment direction) of an airbag 61. Details will be described below.

As illustrated in FIGS. 1-5, the conveyance seat S1 includes the seat main body Sa including a seat cushion 1, the seatback 2, and a headrest 3, the armrest 4 attached to the side portion of the seat main body Sa, a rail device 5 that supports the seat main body Sa so as to be movable in a front-rear direction with respect to a vehicle body floor, a height adjustment device 6 that supports the seat main body Sa so as to be movable in the up-down direction with respect to the vehicle body floor, and a reclining device 7 that pivotably couples the seatback 2 to the seat cushion 1.

The conveyance seat S1 includes the airbag device 60 that is attached to the side portion of the seat main body Sa and protects the seated occupant by causing the airbag 61 to bulge when an external impact is applied.

The armrest 4 and the airbag device 60 are disposed at positions close to each other at the side portion of the seat main body Sa (seatback 2).

As illustrated in FIGS. 1-3, the seat cushion 1 is a seating portion that supports the seated occupant from below, and includes a cushion frame 10 serving as a framework, a padding material 1a placed on the cushion frame 10, and a skin material 1b covering the cushion frame 10 and the padding material 1a.

The seatback 2 is a backrest portion that supports the seated occupant from behind, and includes a back frame 20, a padding material 2a, and a skin material 2b.

The airbag device 60 is assembled inside a side portion of the seatback 2, and the armrest 4 is assembled outside the side portion of the seatback 2.

The headrest 3 is a head portion that supports the head of the seated occupant from behind, and includes head stays 3a serving as a framework, a padding material 3b, and a skin material 3c.

The head stay 3a is attached to a pair of stay attachment portions 22a provided on the back frame 20. The headrest 3 (head stay 3a) is attached to the seatback 2 so as to be movable in the up-down direction.

The armrest 4 is an arm portion that supports the arm portion of the seated occupant, and is pivotably attached to the side portion of the seatback 2 via the arm attachment bracket 40.

The armrest 4 is configured to be switchable between a “stored position” where the armrest 4 extends in the up-down direction along the back frame 20 (side frame 21) as illustrated in FIG. 2 and a “use position” where the armrest 4 pivoting from the stored position is positioned and extends forward from the back frame 20 as illustrated in FIG. 1.

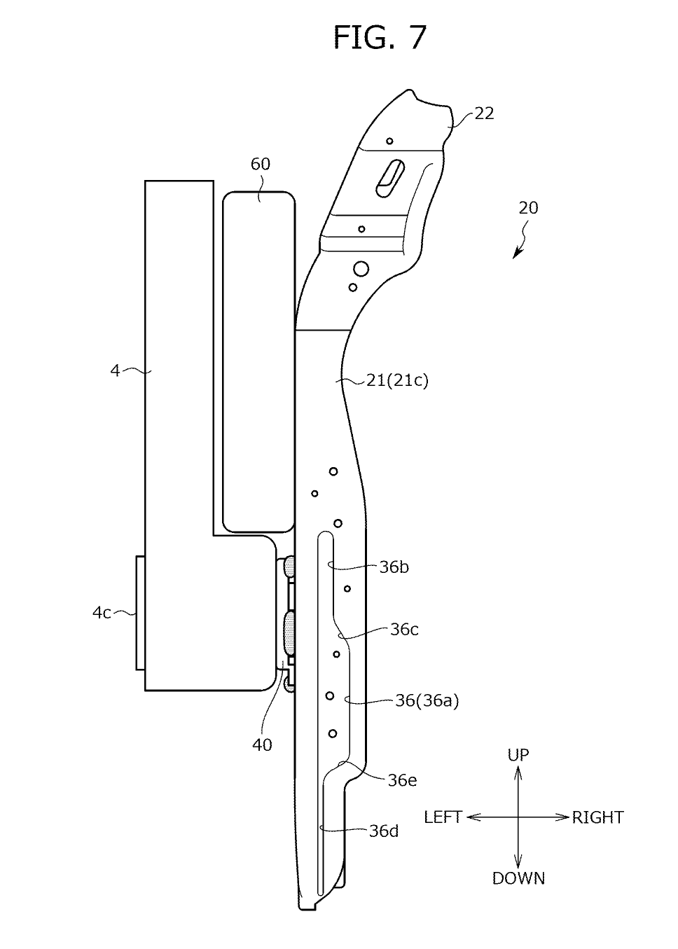

As illustrated in FIG. 7, the armrest 4 is disposed so as to sandwich the airbag device 60 with the back frame 20 (side frame 21) in a seat width direction.

As illustrated in FIGS. 1 and 2, when the armrest 4 is at the “use position”, the armrest 4 is disposed at a position different from that of the airbag device 60 in a seat side view.

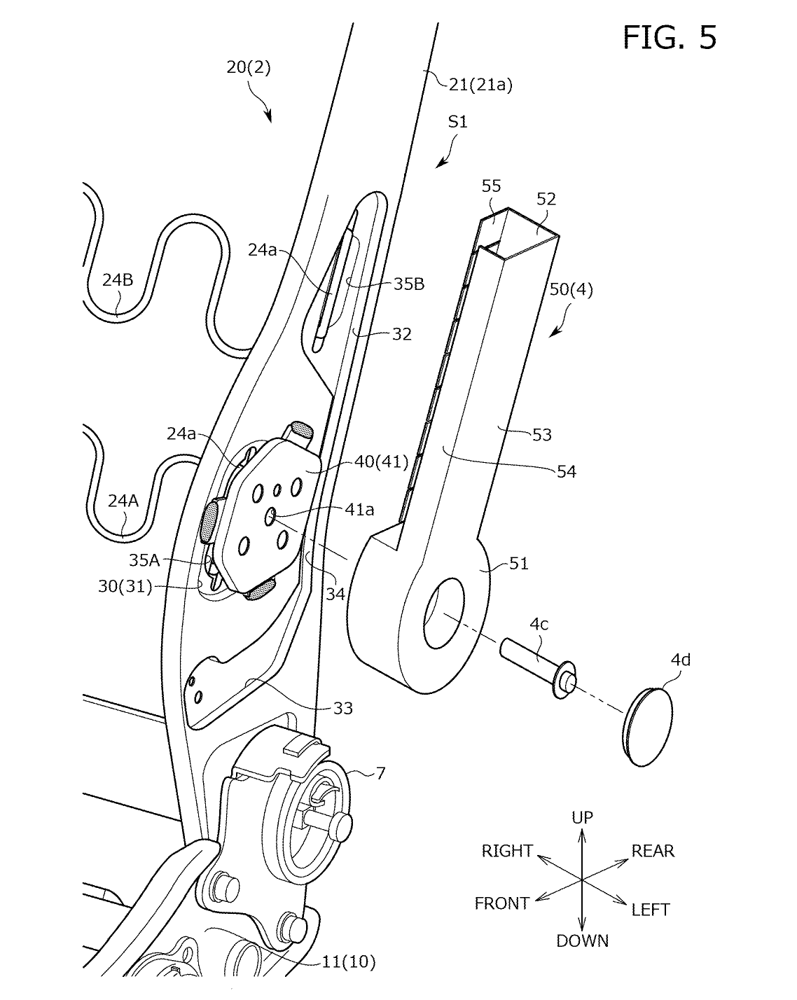

As illustrated in FIGS. 1 and 5, the armrest 4 includes an arm frame 50 serving as a framework, an arm padding material 4a placed on the arm frame 50, and an arm skin material 4b covering the arm frame 50 and the arm padding material 4a.

In addition, the armrest 4 includes an arm pivoting shaft 4c that couples the arm attachment bracket 40 and the arm frame 50, and a shaft cover 4d that is made of a resin and protects the arm pivoting shaft 4c from the outside.

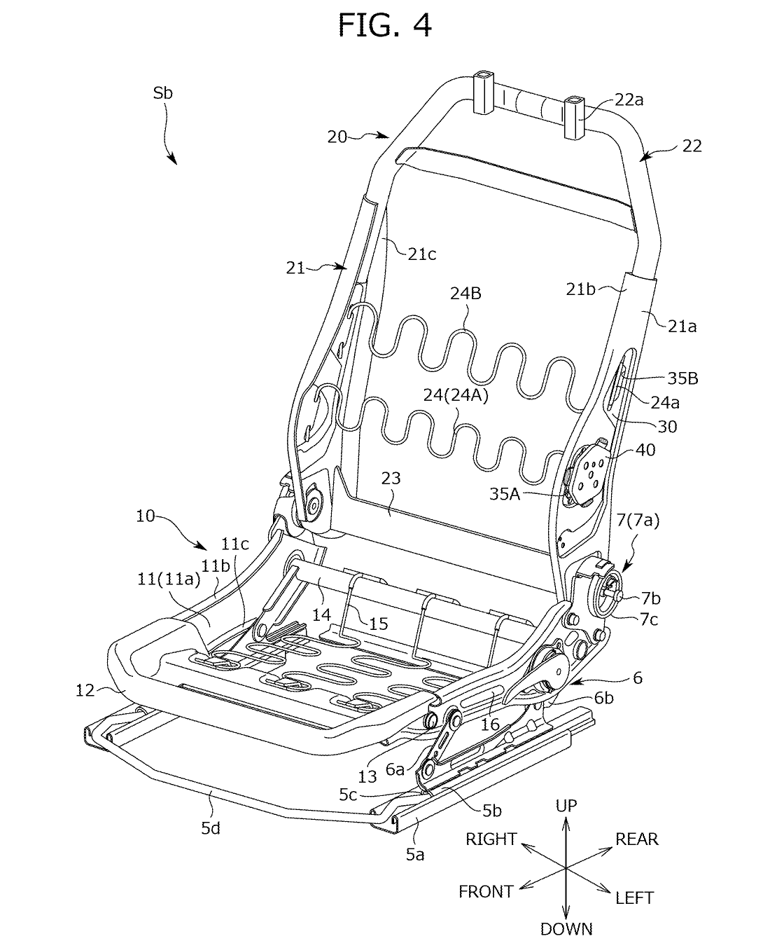

As illustrated in FIGS. 1 and 4, the rail device 5 is disposed between the seat cushion 1 and the vehicle body floor in the up-down direction.

The rail device 5 includes right and left lower rails 5a fixed to the vehicle body floor and extending in a seat front-rear direction, right and left upper rails 5b supported so as to be slidable along the lower rails 5a, a locking member 5c that locks the upper rails 5b so as to be unslidable with respect to the lower rails 5a, and a rail operation lever 5d that releases a locked state of the locking member 5c.

As illustrated in FIG. 4, the seat cushion 1 (cushion frame 10) is attached to upper surfaces of the right and left upper rails 5b via the height adjustment device 6.

As illustrated in FIGS. 1 and 4, the height adjustment device 6 includes right and left first links 6a disposed on the seat front side, right and left second links 6b disposed on a seat rear side, a locking member that locks the seat cushion 1, a height operation lever that releases a locked state of the locking member, and a drive motor.

The second link 6b serves as a drive link to adjust a height of the seat main body.

As illustrated in FIGS. 1, 4, and 5, the reclining device 7 includes a reclining main body 7a that is driven when pivoting the seatback 2, a back pivoting shaft 7b, a spiral spring 7c that biases the seatback 2 to rotate forward about the back pivoting shaft 7b, and a reclining operation lever that is operated to unlock the seatback 2.

The reclining main body 7a can switch a state of the seatback 2 between a “locked state” in which the seatback 2 is fixed to the seat cushion 1 and an “unlocked state” in which the seatback 2 is pivotable with respect to the seat cushion 1.

The back pivoting shaft 7b is pivotally supported by the cushion frame 10 and the back frame 20 in the seat width direction. One end portion of the spiral spring 7c is locked to the cushion frame 10, and the other end portion is locked to the back frame 20.

As illustrated in FIG. 4, the cushion frame 10 is formed of a rectangular frame-shaped body, and includes cushion side frames 11 disposed on right and left sides and extending in the front-rear direction, a plate-shaped pan frame 12 bridged over front end portions of the respective cushion side frames 11, a front coupling frame 13 and a rear coupling frame 14 that respectively couple front portions and rear portions of the cushion side frames 11, and a plurality of elastic springs 15 (linear support members) hooked to the pan frame 12 and the rear coupling frame 14 and extending in a serpentine shape in the front-rear direction.

As illustrated in FIG. 4, the cushion side frame 11 is a plate-shaped frame elongated in the front-rear direction, and includes a frame main body 11a, and a frame upper wall portion 11b and a frame bottom wall portion 11c that protrude by being respectively bent outward in the seat width direction from an upper end portion and a lower end portion of the frame main body 11a.

A reinforcing portion 16 having an uneven structure is formed on an outer surface of the frame main body 11a.

The reclining device 7 is attached to a rear end portion of the cushion side frame 11.

As illustrated in FIG. 4, each of the front coupling frame 13 and the rear coupling frame 14 is a pipe-shaped frame, and couples the right and left cushion side frames 11 and couples the right and left links (the first links 6a and the second links 6b).

The plurality of elastic springs 15 are linear support members that support the buttocks of the seated occupant, and are provided at predetermined intervals in the seat width direction.

As illustrated in FIGS. 4-7, the back frame 20 is formed of a rectangular frame-shaped body, and includes the side frames 21 disposed on right and left sides, an upper frame 22 coupling upper end portions of the respective side frames 21, a lower frame 23 coupling lower end portions of the respective side frames 21, and a plurality of support members 24 hooked to the side frames 21 and extending in a right-left direction.

### Side Frame

As illustrated in FIGS. 5-7, the side frame 21 is a plate-shaped frame elongated in the up-down direction, and includes a frame main body 21a extending in the up-down direction, a frame front wall portion 21b extending inward in the seat width direction from a front end portion of the frame main body 21a, and a frame rear wall portion 21c extending inward in the seat width direction from a rear end portion of the frame main body 21a.

A reinforcing recess 30 is formed on an outer surface of the frame main body 21a. The arm attachment bracket 40 and the airbag device 60 are assembled to the outer surface of the frame main body 21a.

A rear reinforcing recess 36 extending in the up-down direction is formed on a rear surface of the frame rear wall portion 21c.

The support members 24 are linear support members that support the back of the seated occupant from behind, and are also referred to as elastic springs.

The support members 24 include a linear first support member 24A and a linear second support member 24B disposed at intervals in the up-down direction.

An extending end portion 24a of the first support member 24A is hooked to a first hooking portion 35A formed on the outer surface of the side frame 21 (frame main body 21a).

An extending end portion 24a of the second support member 24B is hooked to a second hooking portion 35B formed on the outer surface of the side frame 21.

### Reinforcing Portion of Side Frame

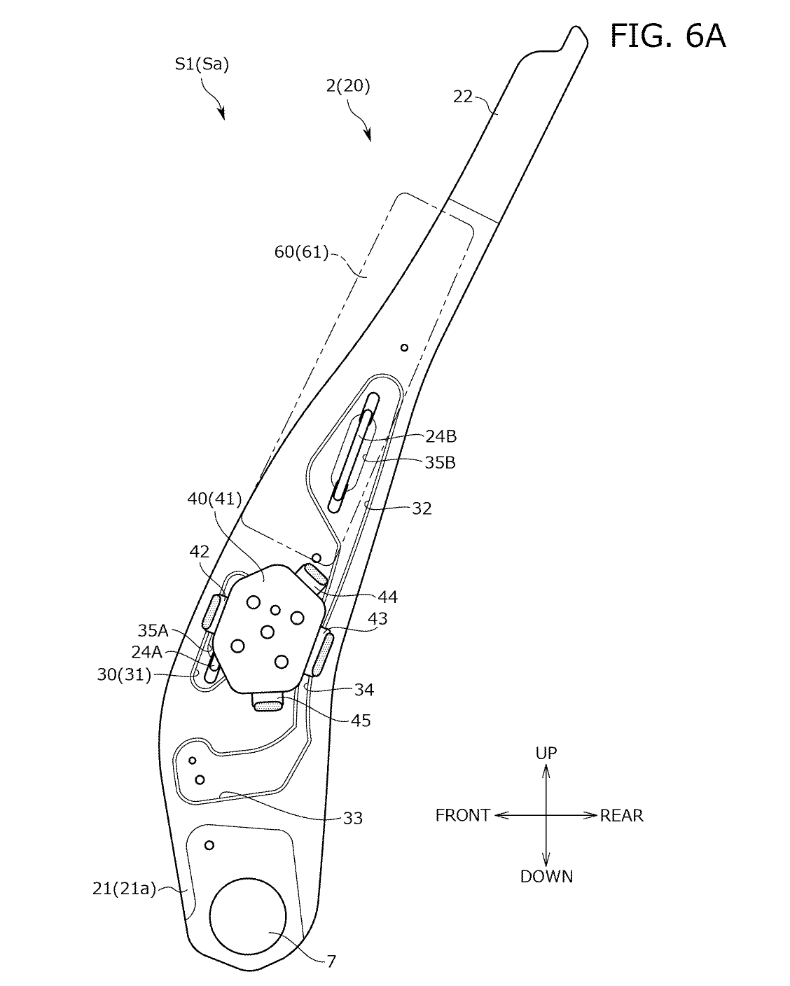

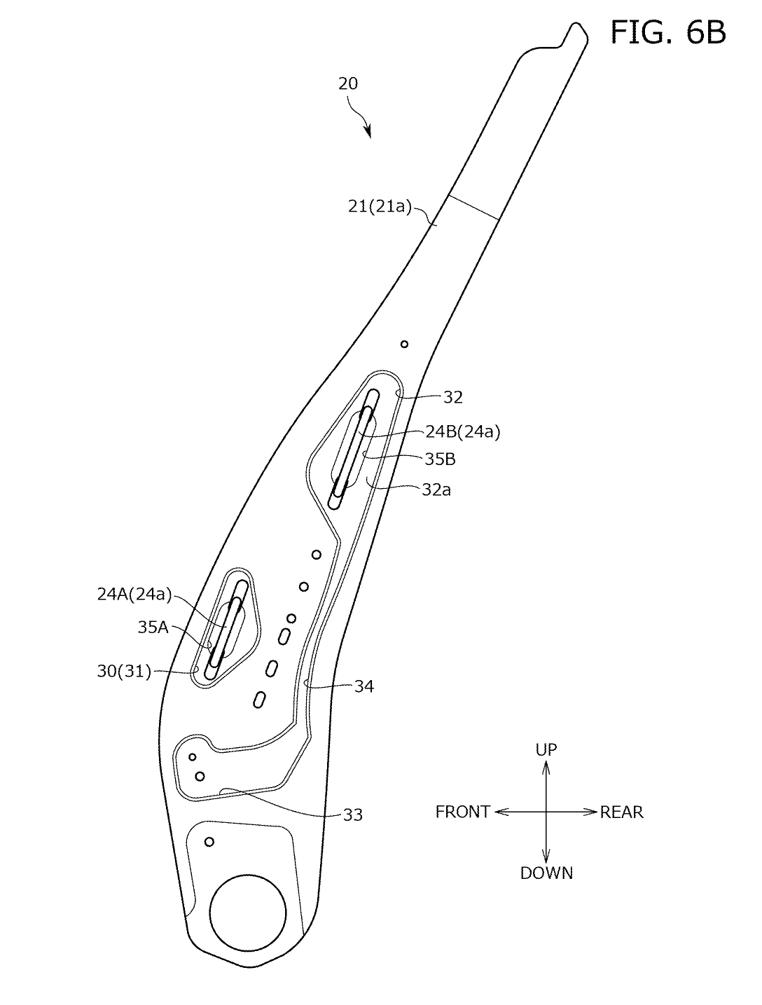

As illustrated in FIGS. 5-6B, the reinforcing recess 30 is a reinforcing portion that reinforces the side frame 21, and is recessed inward on the outer surface of the frame main body 21a. The reinforcing recess 30 is also referred to as a reinforcing bead.

A protruding reinforcing protrusion may be formed instead of the reinforcing recess 30.

The reinforcing recess 30 includes a first reinforcing recess 31 having a substantially semicircular shape, a second reinforcing recess 32 formed at a portion above the first reinforcing recess 31, a third reinforcing recess 33 formed at a portion below the first reinforcing recess 31, and a coupling reinforcing recess 34 formed at a portion behind the first reinforcing recess 31 and coupling the second reinforcing recess 32 and the third reinforcing recess 33.

The arm attachment bracket 40 is attached so as to overlap a portion of the outer surface of the side frame 21 where the first reinforcing recess 31 is formed.

As illustrated in FIG. 6A, the arm attachment bracket 40 is disposed so as to be surrounded by the first reinforcing recess 31, the second reinforcing recess 32, the third reinforcing recess 33, and the coupling reinforcing recess 34 in the seat side view.

In addition, the first hooking portion 35A is formed so as to overlap a portion of the outer surface of the side frame 21 where the first reinforcing recess 31 is formed.

The second reinforcing recess 32 is a reinforcing portion extending so as to be vertically elongated, and is disposed such that the second reinforcing recess 32 and the airbag device 60 overlap each other in the seat side view.

The second hooking portion 35B is formed so as to overlap a portion of the outer surface of the side frame 21 where the second reinforcing recess 32 is formed.

The third reinforcing recess 33 is a reinforcing portion extending in the front-rear direction, and a rear end portion of the third reinforcing recess 33 is coupled to the coupling reinforcing recess 34.

The coupling reinforcing recess 34 extends so as to be elongated in the up-down direction, and couples the rear end portion of the third reinforcing recess 33 and a lower end portion of the second reinforcing recess 32.

The coupling reinforcing recess 34 is formed to be narrower than the reinforcing recesses 31, 32, and 33 in the front-rear direction.

As illustrated in FIG. 6B, the first hooking portion 35A is a portion (recessed portion) which is formed at a portion of the outer surface of the frame main body 21a that overlaps the first reinforcing recess 31 and to which the extending end portion 24a of the first support member 24A is hooked.

The second hooking portion 35B is a portion (recessed portion) which is formed at a portion of the outer side surface of the frame main body 21a that overlaps the second reinforcing recess 32 and to which the extending end portion 24a of the second support member 24B is hooked.

Specifically, the first reinforcing recess 31 has a bottom surface 31a, and the second reinforcing recess 32 has a bottom surface 32a, the bottom surfaces 31a and 32a being formed in a planar shape along the outer surface of the frame main body 21a.

The first hooking portion 35A is formed on the bottom surface 31a of the first reinforcing recess 31, and the second hooking portion 35B is formed on the bottom surface 32a of the second reinforcing recess 32.

More specifically, as illustrated in FIG. 6B, the first hooking portion 35A is formed as a step portion on the bottom surface 31a of the first reinforcing recess 31. The extending end portion 24a of the first support member 24A penetrates through the side frame 21 and is hooked so as to be accommodated in the step portion of the first hooking portion 35A.

Further, the extending end portion 24a of the first support member 24A is disposed so as not to protrude from the outer surface of the side frame 21 (frame main body 21a) in the seat width direction when being hooked to the step portion of the first hooking portion 35A.

Similarly, the second hooking portion 35B is also formed as a step portion on the bottom surface 32a of the second reinforcing recess 32. The extending end portion 24a of the second support member 24B is hooked so as to be accommodated in the second hooking portion 35B.

With the above configuration, the extending end portion 24a of the first support member 24A (second support member 24B) can be accommodated in the first reinforcing recess 31 (second reinforcing recess 32) of the side frame 21, and can be disposed so as not to protrude from the side frame 21.

In particular, as the extending end portion 24a of the first support member 24A is hooked to the step portion of the first hooking portion 35A, the extending end portion 24a can be appropriately accommodated in the outer surface of the frame main body 21a. As a result, it is possible to suppress interference with the padding material 2a, the skin material 2b, and the like of the seatback 2.

### Rear Reinforcing Portion of Side Frame

As illustrated in FIG. 7, the rear reinforcing recess 36 is a reinforcing portion that reinforces the side frame 21, and is recessed forward on the rear surface of the frame rear wall portion 21c. The rear reinforcing recess 36 is also referred to as a reinforcing bead.

The rear reinforcing recess 36 includes a first portion 36a extending in the up-down direction, a second portion 36b provided at a position upward of the first portion 36a and formed to be narrower than the first portion 36a, and a coupling portion 36c coupling the first portion 36a and the second portion 36b and narrowing from the first portion 36a toward the second portion 36b.

The rear reinforcing recess 36 includes a third portion 36d provided at a position downward of the first portion 36a and formed to be narrower than the first portion 36a, and a coupling portion 36e coupling the first portion 36a and the third portion 36d and narrowing from the first portion 36a toward the third portion 36d.

### Arm Attachment Bracket

As illustrated in FIGS. 4-8B, the arm attachment bracket 40 is a bracket that is attached to the outer surface of the side frame 21 and pivotably attaches the armrest 4 to the side frame 21. The arm attachment bracket 40 is also referred to as a pivoting bracket.

As illustrated in FIGS. 5, 6A, 8A, and 8B, the arm attachment bracket 40 includes a plate-shaped bracket main body 41, and a first flange 42, a second flange 43, a third flange 44, and a fourth flange 45 that protrude outward from an outer peripheral portion of the bracket main body 41.

A shaft hole 41a is formed at a central portion of the bracket main body 41, and the arm pivoting shaft 4c is pivotally supported by the shaft hole 41a.

The first flange 42 is formed at a front end portion of the bracket main body 41, and is bonded to a portion of the outer surface of the side frame 21 where the first reinforcing recess 31 is formed by welding. In other words, a “welding mark” is formed in the periphery of a portion where the first flange 42 and the first reinforcing recess 31 are welded.

The second flange 43 is formed at a rear end portion of the bracket main body 41, and is bonded to a portion of the outer surface of the side frame 21 where the coupling reinforcing recess 34 is formed by welding.

The third flange 44 is formed at an upper end portion of the bracket main body 41, and is bonded to a portion of the outer surface of the side frame 21 between the first reinforcing recess 31 and the second reinforcing recess 32 by welding.

The fourth flange 45 is formed at a lower end portion of the bracket main body 41, and is bonded to a portion of the outer surface of the side frame 21 between the first reinforcing recess 31 and the third reinforcing recess 33 by welding.

The number of flanges and the number of bonded portions can be appropriately changed. The flanges may be concentrated on a front side of the bracket main body 41 or may be concentrated on a rear side of the bracket main body 41.

In the above configuration, as illustrated in FIGS. 5 and 6A, the arm attachment bracket 40 is disposed so as to overlap a portion of the first reinforcing recess 31 in the seat side view, and is disposed so as to overlap a portion of the coupling reinforcing recess 34.

The arm attachment bracket 40 is disposed between the second reinforcing recess 32 and the third reinforcing recess 33 in the up-down direction.

As a result, the arm attachment bracket 40 can be assembled to a portion of the side frame 21 reinforced by the reinforcing recesses 31, 32, 33, and 34, and the assembling strength of the armrest 4 can be enhanced.

The arm attachment bracket 40 may be disposed so as to overlap substantially the entire portion of the first reinforcing recess 31.

In the above configuration, as illustrated in FIG. 6A, the arm attachment bracket 40 is disposed so as to straddle the first reinforcing recess 31 and the coupling reinforcing recess 34 in the front-rear direction.

The arm attachment bracket 40 is disposed between a rear end portion of the second reinforcing recess 32 and a front end portion of the third reinforcing recess 33 in the front-rear direction.

As a result, the arm attachment bracket 40 can be assembled to the portion of the side frame 21 reinforced by the reinforcing recesses 31, 32, 33, and 34.

In the above configuration, as illustrated in FIG. 7, the arm attachment bracket 40 is disposed between an upper end portion and a lower end portion of the rear reinforcing recess 36 in a seat rear view.

An upper end portion of the arm attachment bracket 40 is disposed at a position upward of an upper end portion of the coupling portion 36c, and a lower end portion of the arm attachment bracket is disposed at a position downward of a lower end portion of the coupling portion 36c.

By forming the frame rear wall portion 21c and the rear reinforcing recess 36 in this manner, a portion of the side frame 21 to which the arm attachment bracket 40 is assembled and a peripheral portion thereof can be reinforced.

### Arm Frame

As illustrated in FIG. 5, the arm frame 50 is a frame having a substantially L-shaped cross section and serving as a framework of the armrest 4.

The arm frame 50 includes an arm frame main body 51 assembled to the arm attachment bracket 40, a support frame portion 52, a side frame portion 53, and a facing frame portion 54.

The armrest 4 is provided with an arm deformation portion 55 that is deformed according to the bulging and deployment of the airbag 61 to allow the bulging and deployment of the airbag 61.

The arm frame main body 51 is pivotably coupled to the arm attachment bracket 40 fixed to the side frame 21 by the arm pivoting shaft 4c.

The support frame portion 52 is a planar frame extending in the seat width direction, and is a frame that supports the arm portion of the seated occupant when the armrest 4 is at the “use position” illustrated in FIG. 1.

The side frame portion 53 is a frame positioned on a side of the armrest 4 opposite to a side where the airbag device 60 is positioned, and is a planar frame extending from one end portion of the support frame portion 52 in a direction orthogonal to an extending direction of the support frame portion 52.

The facing frame portion 54 is a frame at a position facing the support frame portion 52, and is a planar frame extending in the seat width direction from one end portion of the side frame portion 53.

### Arm Deformation Portion

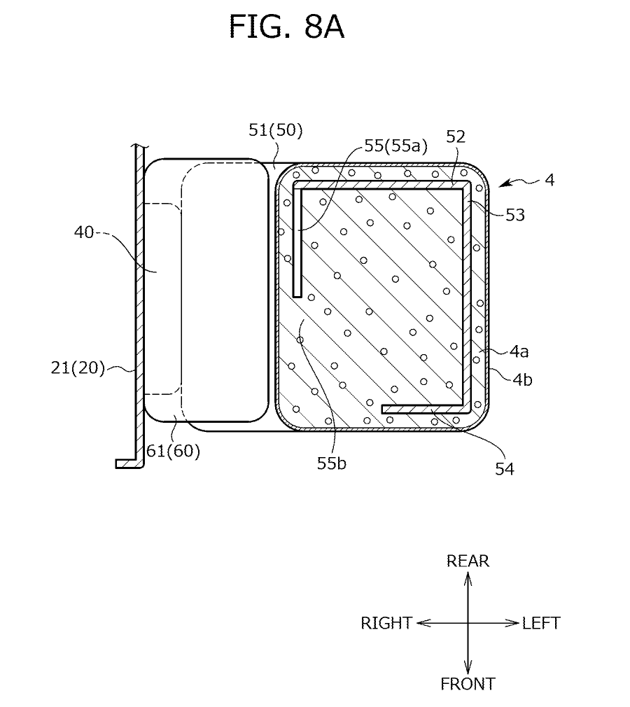

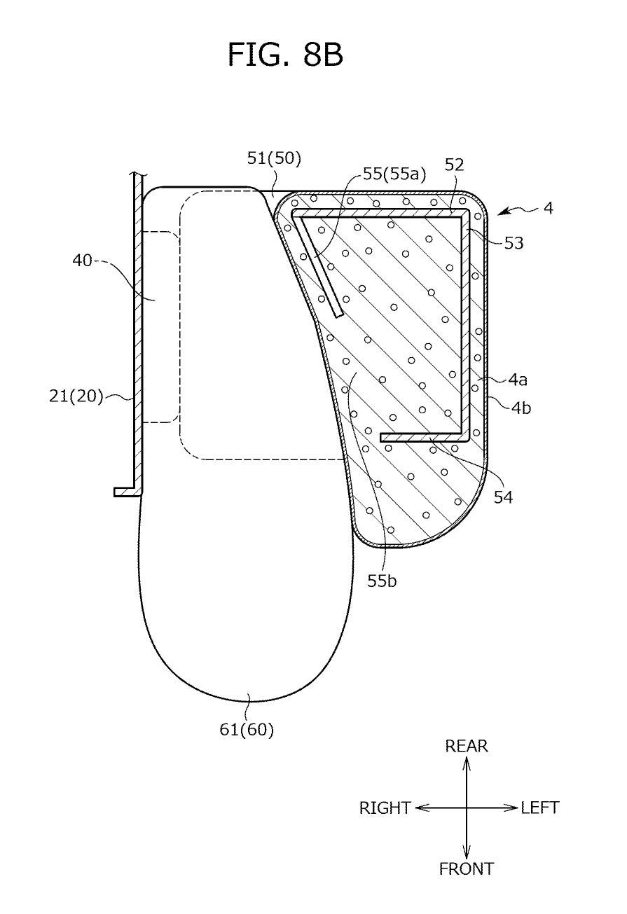

As illustrated in FIGS. 5, 8A, and 8B, the arm deformation portion 55 is provided at a side portion of the armrest 4 close to the airbag device 60.

Strictly speaking, as illustrated in FIG. 8A, the arm deformation portion 55 is provided at each of the side portion of the armrest 4 close to the airbag device 60 and a front portion of the armrest 4 when the armrest 4 is at the “stored position”.

Specifically, the arm deformation portion 55 includes a planar deformable frame portion 55a (deformable frame portion) extending in a direction orthogonal to the extending direction from the other end portion of the support frame portion 52, and an arm padding portion 55b covering the deformable frame portion 55a.

In other words, the arm frame 50 is not provided with a portion (corner portion) coupling the deformable frame portion 55a and the facing frame portion 54.

Note that the arm deformation portion 55 (deformable frame portion 55a) may be referred to as a “weakened frame portion”.

### Airbag Device

As illustrated in FIGS. 1-3, 6A, and 7, the airbag device 60 is a “protection device (seated occupant protection device)” for mitigating an impact applied to the seated occupant when the impact is received from a side of a conveyance.

The airbag device 60 is also referred to as a side airbag device, and is mounted inside the side portion of the seatback 2.

The airbag device 60 includes the airbag 61 (bulging object) that can bulge, and an inflator 62 that supplies gas into the airbag 61. Specifically, an airbag module including the airbag 61 and the inflator 62 is provided.

The airbag device 60 is assembled to the outer surface of the side frame 21, is disposed at a position upward of the arm attachment bracket 40, and is disposed between the side frame 21 and the armrest 4 in the seat width direction.

As illustrated in FIG. 2, the airbag device 60 is disposed at a position overlapping the armrest 4 in the seat side view when the armrest 4 is at the “stored position”. The airbag device 60 is disposed so as not to overlap the armrest 4 in the seat side view when the armrest 4 is at the “deployed position”.

As described above, the airbag device 60 and the armrest 4 are compactly disposed while interference between the airbag device 60 and the armrest 4 is suppressed at the side portion of the seatback 2.

In the above configuration, as illustrated in FIGS. 8A and 8B, when the airbag 61 bulges and is deployed forward while the armrest 4 is at the “stored position”, the arm deformation portion 55 is deformed so as to allow the bulging and deployment of the airbag 61.

Specifically, the deformable frame portion 55a of the arm deformation portion 55 rotates outward in the seat width direction about a portion coupled to the support frame portion 52 so as to avoid the bulging airbag 61.

Further, the arm padding portion 55b of the arm deformation portion 55 is elastically deformed outward (leftward) in the seat width direction so as to avoid the bulging airbag 61.

As described above, by deforming a part of the armrest 4 when the airbag 61 bulges, it is possible to suppress an influence on the bulging and deployment (bulging and deployment direction) of the airbag 61.

With the above-described conveyance seat S1, it is possible to increase the assembling strength of the armrest 4 with respect to the side portion of the seatback 2.

In addition, the armrest 4 (arm attachment bracket 40) can be suitably disposed at the side portion of the seatback 2.

In addition, the airbag 61 can appropriately bulge and be deployed.

### First Modification of Armrest

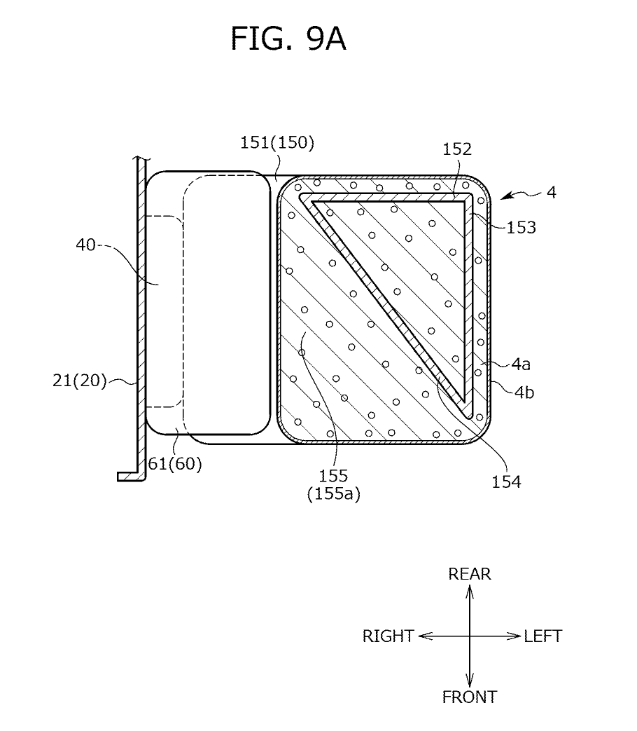

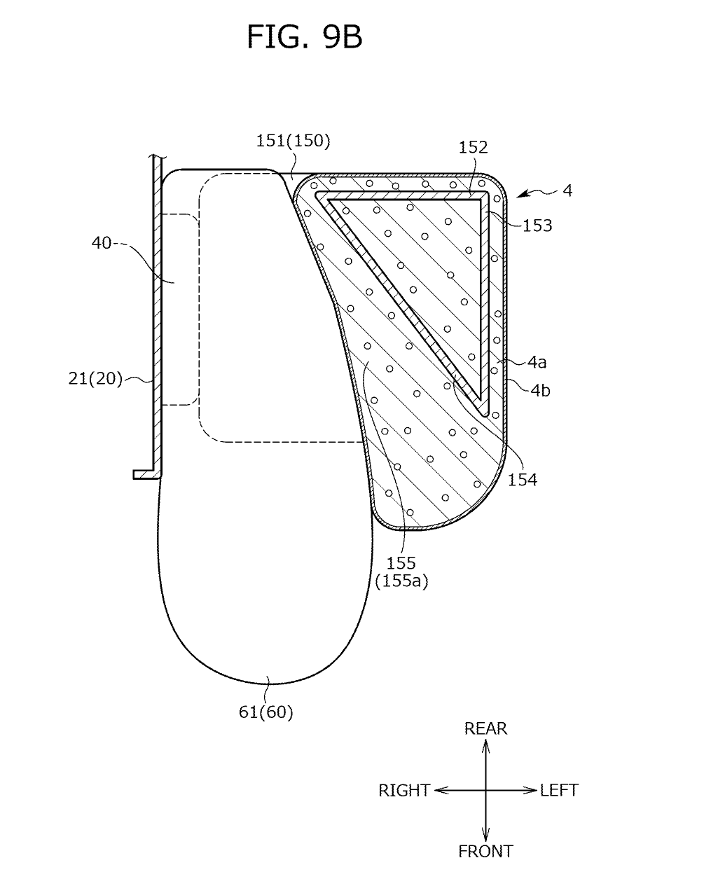

Next, an armrest of a first modification will be described with reference to FIGS. 9A and 9B.

FIG. 9A is a top view of the side frame 21, the arm attachment bracket 40, an armrest 4, and the airbag device 60. FIG. 9B is a view illustrating a state in which the airbag device 60 (airbag 61) bulges and is deployed from a state of FIG. 9A.

The armrest 4 of the first modification includes an arm frame 150, an arm padding material 4a, and an arm skin material 4b.

The arm frame 150 includes an arm frame main body 151, a support frame portion 152, a side frame portion 153, and an inclined frame portion 154.

The inclined frame portion 154 is a planar frame that couples the other end portion of the support frame portion 152 in an extending direction and an extending end portion of the side frame portion 153 and extends in an inclined manner.

The armrest 4 is provided with an arm deformation portion 155 that allows the bulging and deployment of the airbag 61.

As illustrated in FIG. 9A, the arm deformation portion 155 is provided at a side portion of the armrest 4 close to the airbag device 60 and a front portion of the armrest 4.

Specifically, the arm deformation portion 155 includes an arm padding portion 155a which is a part of the arm padding material 4a.

Note that, in view of the fact that the arm frame 150 is devised so as not to affect the bulging and deployment of the airbag 61, it may be expressed that the arm deformation portion 155 includes the arm padding portion 155aand the inclined frame portion 154.

In the above configuration, as illustrated in FIGS. 9A and 9B, when the airbag 61 bulges and is deployed forward while the armrest 4 is at the “stored position”, the arm deformation portion 155 is deformed so as to allow the bulging and deployment of the airbag 61.

Specifically, the arm padding portion 155a is elastically deformed outward and forward in the seat width direction so as to avoid the bulging airbag 61.

The arm frame 150 (inclined frame portion 154) is disposed so as to avoid a region where the airbag 61 bulges and is deployed.

As described above, by deforming a part of the armrest 4 when the airbag 61 bulges, it is possible to suppress an influence on the bulging and deployment of the airbag 61.

### Second Modification of Armrest

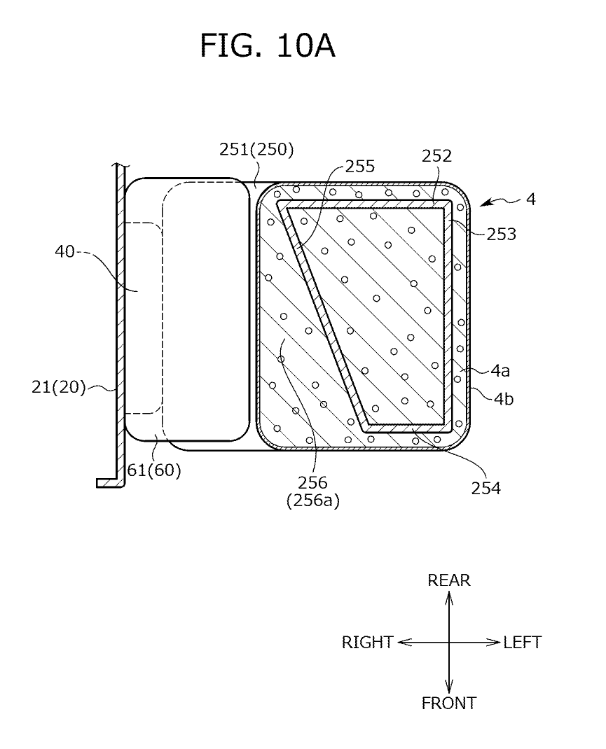

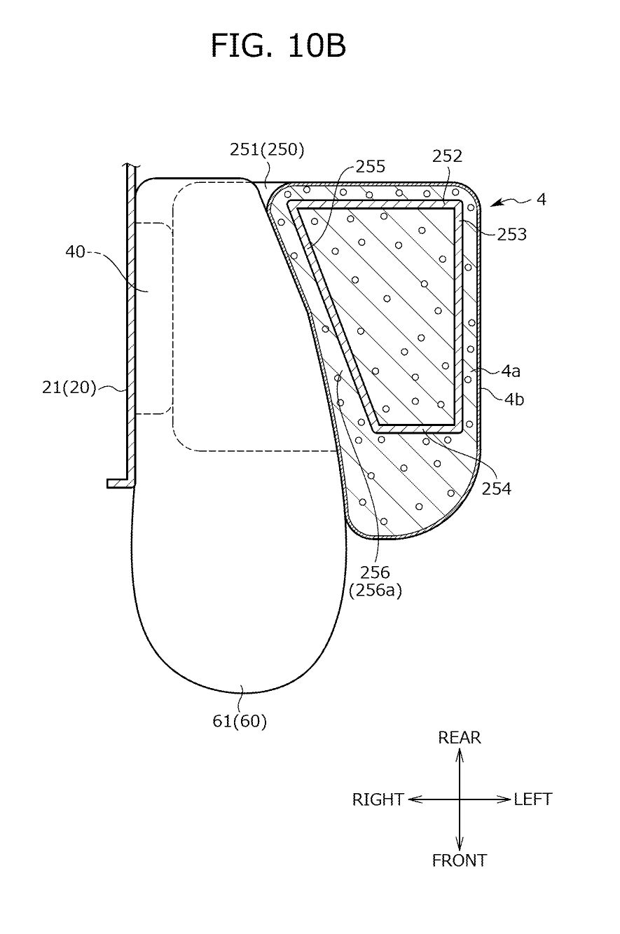

Next, an armrest of a second modification will be described with reference to FIGS. 10A and 10B.

An armrest 4 of the second modification includes an arm frame 250, an arm padding material 4a, and an arm skin material 4b.

The arm frame 250 includes an arm frame main body 251, a support frame portion 252, a side frame portion 253, a facing frame portion 254, and an inclined frame portion 255.

The inclined frame portion 255 is a planar frame that couples the other end portion of the support frame portion 252 in an extending direction and an extending end portion of the facing frame portion 254 and extends in an inclined manner.

The armrest 4 is provided with an arm deformation portion 256 that allows the bulging and deployment of the airbag 61.

As illustrated in FIG. 10A, the arm deformation portion 256 is provided at a side portion of the armrest 4 close to the airbag device 60 and a front portion of the armrest 4.

Specifically, the arm deformation portion 256 includes an arm padding portion 256a which is a part of the arm padding material 4a.

Note that, in view of the fact that the arm frame 250 is devised so as not to affect the bulging and deployment of the airbag 61, it may be expressed that the arm deformation portion 256 includes the arm padding portion 256a and the inclined frame portion 255.

In the above configuration, as illustrated in FIGS. 10A and 10B, when the airbag 61 bulges and is deployed forward while the armrest 4 is at the “stored position”, the arm deformation portion 256 is deformed so as to allow the bulging and deployment of the airbag 61.

Specifically, the arm padding portion 256a is elastically deformed outward and forward in the seat width direction so as to avoid the bulging airbag 61.

The arm frame 250 (inclined frame portion 255) is disposed so as to avoid a region where the airbag 61 bulges and is deployed.

As described above, by deforming a part of the armrest 4 when the airbag 61 bulges, it is possible to suppress an influence on the bulging and deployment of the airbag 61.

### Manufacturing Method for Conveyance Seat

Next, a manufacturing method for the conveyance seat S1 will be described with reference to FIGS. 1-8B.

In the manufacturing method for the conveyance seat S1, description of manufacturing processes other than the following will be omitted.

First, the seat main body Sa including the seat cushion 1 and the seatback 2 and the armrest 4 are prepared.

Then, the seatback 2 is assembled to the seat cushion 1.

Specifically, a lower end portion of the back frame 20 (side frame 21) is assembled to a rear end portion of the cushion frame 10 (cushion side frame 11) via the reclining device 7.

Then, the airbag device 60 is assembled to the side portion of the seatback 2.

Specifically, the airbag device 60 is assembled to the outer surface of the back frame 20 (side frame 21).

Then, the armrest 4 is assembled to the side portion of the seatback 2.

Specifically, the armrest 4 is assembled to the outer surface of the back frame 20 (side frame 21) via the arm attachment bracket 40.

At this time, the armrest 4 is disposed at a position close to the airbag device 60. The armrest 4 is provided with the arm deformation portion 55 that is deformed according to the bulging and deployment of the airbag 61 to allow the bulging and deployment of the airbag 61.

With the above-described manufacturing method for the conveyance seat S1, it is possible to implement the conveyance seat S1 that enables appropriate bulging and deployment of the airbag 61.

In addition, it is possible to implement the conveyance seat S1 in which the arrangement and the configuration of the armrest 4 are devised so as not to affect the bulging and deployment of the airbag 61.

### Others

In the above embodiment, as illustrated in FIG. 8A, the armrest 4 mainly includes the arm frame 50, the arm padding material 4a, and the arm skin material 4b, but is not particularly limited thereto.

For example, the armrest 4 may include a box-shaped “armrest main body” formed of a plastically deformable material, and an “arm skin material” covering the armrest main body. In this case, the armrest 4 may further include an “arm padding material”.

At this time, the box-shaped armrest main body preferably has a crushable structure.

Even with the above configuration, it is possible to implement a conveyance seat in which the configuration of the armrest 4 is devised so as not to affect the bulging and deployment of the airbag 61.

In the above embodiment, as illustrated in FIG. 8A, the arm frame 50 includes the support frame portion 52, the side frame portion 53, and the facing frame portion 54, and is not configured as a continuous frame, but is not particularly limited.

For example, the arm frame 50 may be configured as a rectangular continuous frame, and may be formed such that a lateral width narrows toward a front side of the arm frame 50.

Alternatively, the arm frame 50 may be configured as a rectangular continuous frame, and may be formed such that a front-to-rear width narrows toward the inside of the arm frame 50 in the right-left direction.

Alternatively, the arm frame 50 may have a configuration in which a frame portion is not provided at a front end portion of the armrest 4.

Even with the above configuration, it is possible to implement a conveyance seat in which the configuration of the armrest 4 is devised so as not to affect the bulging and deployment of the airbag 61.

In the above embodiment, as illustrated in FIG. 5, the arm frame 50 includes the planar frame portions 52, 53, and 54. However, the arm frame 50 may also be configured as a linear frame instead of a planar frame. In this case, the linear arm frame may be formed of a hollow member or may be formed of solid member.

In the above embodiment, as illustrated in FIG. 1, the armrest 4 and the airbag device 60 are attached to both the right and left sides of the seatback 2, but are not particularly limited.

The armrest 4 and the airbag device 60 may be attached to a left (inner) side portion of the seatback 2, or may be attached to a right (outer) side portion of the seatback 2.

In the above embodiment, as illustrated in FIGS. 4-6A, the armrest 4 (arm attachment bracket 40) is attached to the outer surface of the back frame 20 (side frame 21), but the armrest 4 may also be attached to an outer surface of the cushion frame 10 (cushion side frame 11).

In this case, the arm attachment bracket 40 may be disposed so as to overlap a part of the reinforcing portion 16 in the seat side view.

In the above embodiment, a vehicle seat (automobile seat) has been described as a specific example, but the present invention is not limited thereto and may be applied to a conveyance seat for an airplane, a ship, and the like in addition to a conveyance seat for a train, a bus, and the like.

In the above embodiment, the conveyance seat according to the present invention has been mainly described.

However, the above embodiment is merely an example for facilitating understanding of the present invention, and does not limit the present invention. The present invention can be modified and improved without departing from the gist thereof, and it goes without saying that the present invention includes equivalents thereof.

### REFERENCE SIGNS LIST

S1 Conveyance seat (vehicle seat)
Sa Seat main body
Sb Seat frame
1 Seat cushion
1a Padding material
1b Skin material
2 Seatback
2a Padding material
2b Skin material
3 Headrest
3a Head stay
3b Padding material
3c Skin material
4 Armrest
4a Arm padding material
4b Arm skin material
4c Arm pivoting shaft
4d Shaft cover
5 Rail device
5a Lower rail
5b Upper rail
5c Locking member
5d Rail operation lever
6 Height adjustment device
6a First link
6b Second link
7 Reclining device
7a Reclining main body
7b Pivoting shaft
7c Spiral spring
10 Cushion frame
11 Cushion side frame (side frame)
11a Frame main body
11b Frame upper wall portion
11c Frame bottom wall portion
12 Pan frame
13 Front coupling frame
14 Rear coupling frame
15 Elastic spring (support member)
16 Reinforcing portion
20 Back frame
21 Side frame (back side frame)
21a Frame main body
21b Frame front wall portion
21c Frame rear wall portion
22 Upper frame
22a Stay attachment portion
23 Lower frame
24 Support member (elastic spring)
24A First support member
24B Second support member
24a Extending end portion
30 Reinforcing recess (reinforcing portion)
31 First reinforcing recess (first reinforcing portion)
31a Bottom surface
32 Second reinforcing recess (second reinforcing portion)
32a Bottom surface
33 Third reinforcing recess (third reinforcing portion)
34 Coupling reinforcing recess (coupling reinforcing portion)
35A First hooking portion (first step portion)
35B Second hooking portion (second step portion)
36 Rear reinforcing recess rear reinforcing portion
36a First portion
36b Second portion
36c Coupling portion
36d Third portion
36e Coupling portion
40 Arm attachment bracket
41 Bracket main body
41a Shaft hole
42 First flange
3 Second flange
44 Third flange
45 Fourth flange
50 Arm frame
51 Arm frame main body
52 Support frame portion
53 Side frame portion
54 Facing frame portion
55 Arm deformation portion
55a Deformable frame portion
55b Arm padding portion
60 Airbag device (protection device and seated occupant protection device)
61 Airbag (bulging object)
62 Inflator
First and Second Modifications
150 Arm frame
152 Support frame portion
153 Side frame portion
154 Inclined frame portion
155 Arm deformation portion
155a Arm padding portion
250 Arm frame
252 Support frame portion
253 Side frame portion
254 Facing frame portion
255 Inclined frame portion
256 Arm deformation portion
256a Arm padding portion

What is claimed is:

1. A conveyance seat including a seat main body, the conveyance seat comprising:
a protection device that is provided at a side portion of the seat main body and protects a seated occupant by causing a bulging object to bulge when an external impact is applied; and
an armrest that is provided at the side portion of the seat main body, wherein
the seat main body includes a side frame provided at the side portion of the seat main body in a seat width direction,
the protection device is attached to an outer surface of the side frame,
the armrest is attached to the outer surface of the side frame and is disposed at a position close to the protection device, and
the armrest is provided with an arm deformation portion that is deformed according to bulging and deployment of the bulging object to allow the bulging and deployment of the bulging object.

2. The conveyance seat according to claim 1, wherein the arm deformation portion is provided at a portion of the armrest close to the protection device.

3. The conveyance seat according to claim 1, wherein
the armrest is configured to be switchable between a stored position where the armrest extends in an up-down direction along the side frame and a use position where the armrest moving from the stored position extends forward from the side frame, and
the arm deformation portion is provided at each of a side portion of the armrest close to the protection device, and a front portion of the armrest when the armrest is at the stored position.

4. The conveyance seat according to claim 1, wherein
the armrest is disposed so as to sandwich the protection device with the side frame in the seat width direction, and
the arm deformation portion is provided at a side portion of the armrest close to the protection device.

5. The conveyance seat according to claim 1, wherein
the armrest is attached so as to be pivotable with respect to the side frame and is switchable between a stored position where the armrest extends in an up-down direction along the side frame and a use position where the armrest pivoting from the stored position extends forward from the side frame,
the armrest includes:
an arm frame that serves as a framework; and
an arm padding material that covers the arm frame,
the arm frame includes:
a support frame portion that supports an arm portion of the seated occupant when the armrest is at the use position; and
a side frame portion that is positioned on a side of the armrest that is opposite to a side where the protection device is positioned, and
the arm deformation portion is provided at a side portion of the armrest that is positioned on the side where the protection device is positioned, and is a portion including the arm padding material.

6. The conveyance seat according to claim 5, wherein the arm frame includes:
the support frame portion that is a planar frame extending in the seat width direction;
the side frame portion that is a planar frame extending from one end portion of the support frame portion in an extending direction of the support frame portion, in a direction orthogonal to the extending direction of the support frame portion; and
an inclined frame portion that is a planar frame coupling the other end portion of the support frame portion in the extending direction and an extending end portion of the side frame portion and extending in an inclined manner.

7. The conveyance seat according to claim 5, wherein the arm frame is a frame having an L-shaped cross section.

8. The conveyance seat according to claim 1, wherein
the armrest is attached to the side frame via an arm attachment bracket, and
the arm attachment bracket is disposed at a position downward of the protection device on the side frame.

9. The conveyance seat according to claim 1, wherein
the armrest is pivotably attached to the side frame via an arm attachment bracket, and is switchable between a stored position where the armrest extends in an up-down direction along the side frame and a use position where the armrest pivoting from the stored position extends forward from the side frame, and
when the armrest is at the use position, the armrest is disposed at a position different from the protection device in a seat side view.

10. The conveyance seat according to claim 1, wherein
the seat main body includes a seat cushion, a seatback, and a headrest,
the seat cushion includes a cushion frame, a padding material, and a skin material,
the seatback includes a back frame, a padding material, and a skin material,
the headrest includes a head frame, a padding material, and a skin material,
the armrest includes an arm frame, an arm padding material, and an arm skin material,
the conveyance seat further comprises:
a reclining device that pivotably couples the seatback to the seat cushion;
a rail device that supports the seat cushion so as to be movable in a front-rear direction with respect to a conveyance floor; and
a height adjustment device that supports the seat cushion so as to be movable in an up-down direction with respect to the rail device,
the headrest is attached to the seatback so as to be movable in the up-down direction, and
the armrest is pivotably attached to a side portion of the seatback via an arm attachment bracket.
